(19) United States
(12) Patent Application Publication
(10) Pub. No.: US 2005/0066682 A1
(43) Pub. Date: Mar. 31, 2005

(54) Cryogenic self-cooling beverage container and process of manufacturing the same

(76) Inventor: Michael M. Anthony, Parkland, FL (US)

Correspondence Address: John H. Oltman;Oltman, Flynn & Kubler, #415, 915 Middle River Drive, Fort Lauderdale, FL, 33304, US

(21) Appl. No.: 10/988,780

(22) Filed: Nov. 15, 2004

Related U.S. Application Data
(63) Continuation-in-part of application No. 10/628,099, filed on Jul. 28, 2003, now Pat. No. 6,817,202.

(51) Int. Cl. B67D 1/00

(52) U.S. Cl. 62/293

(57) ABSTRACT

A self-cooling beverage container includes a container having container bottom and side walls and a container top opening; a top chamber removably fastened to the container side wall and closing the container top opening, the top chamber having a chamber top opening removably fitted with a chamber cap and having a chamber bottom opening with a holding structure having a gas passing passageway with pressure receptacle mounting means; a pressure receptacle containing a refrigerant and having a receptacle opening and being removably mounted to the,pressure receptacle mounting means and extending downwardly into the container; and an actuation mechanism causing escape of the refrigerant from the receptacle and from the container upon opening of the chamber cap.

### RELATED APPLICATION

This application is a Continuation-in-Part of co-pending application Ser. No. 10/628,099 filed on Jul. 28, 2003.

### BACKGROUND OF THE INVENTION

1. Field of the Invention

The present invention relates generally to the field of food and beverage containers and to processes for manufacturing such containers with cryogenic high pressure gases of various kinds. More specifically the present invention relates to a self-cooling beverage container apparatus containing a beverage or other food product, a method of storing cryogenic gases which then cool said food products, and to methods of assembling and operating the apparatus. The terms “beverage”, “food,” “food products” and “container contents” are considered as equivalent for the purposes of this application and used interchangeably.

2. Description of the Prior Art

There have previously been self-cooling container for cooling the contents such as food or beverages that include flexible and deformable receptacles with widely spaced apart, rigid receptacle walls, and methods of manufacturing these containers. These prior art do not address the real issues of manufacturing and beverage plant operations that are crucial for the success of a self-cooling beverage container program. All prior art designs fail to show how to incorporate high pressure gases. Many trials and designs were done to obtain the present configuration of the disclosed receptacle of this invention. No prior art teaches how to manufacture a self-cooling beverage plastic bottle as a simple integrated and manufacturable unit that will conform to the standards of the beverage industry.

For example prior art teaches how to make high pressure containers made from steel or small diameter tubing. Since such receptacles are generally made from thick-walled materials for containing high pressure, rapid heat transfer is limited and almost impossible. Even with prior designs of co-seamed internal receptacles such as that described in U.S. Pat. No. 6,065,300 to the present inventor the problem was still not solved. Also, the high speed beverage plants require high speed compatible operations for manufature of an online self-cooling beverage container. For example, prior art designs do not address easy insertion, self-aligning of the receptacle with the container and so on, particularly when the container is a plastic bottle. Further, most prior art relies on a separate unintegrated manufacturing process for the attachment of the receptacle to the container. The prior art differs from the current disclosed invention in that they all require complicated valving for activation of the cooling process. Most use complicated gaskets and expensive attachment means. The present invention does not require a special valving system Just a few parts that form the receptacle and the attachment means to the bottle suffice to form a self acting valve based on the opening of the container for consumption. U.S. Pat. No. 6581,401,B1 invented by the present inventor shows a technology based on phase locked refrigerants that are only used to cool a beverage container such as a can or bottle. This invention is an improvement over said patent and discloses a novel technology for bottles also with the additional aspect of using cryogenic propellant mixtures such as carbon dioxide. The reason for the improvement is that no other technology addresses the high pressure container costs associated with the manufacture of metal containers.

### SUMMARY OF THE INVENTION

The present invention accomplishes the above-stated objectives, as well as others, as may be determined by a fair reading and interpretation of the entire specification.

For the preferred of several possible embodiments, the apparatus includes a conventional beverage or food container such as a plastic bottle for containing a product to be consumed. In the preferred embodiment, the container is an injection-stretch-blown plastic bottle with a conventional unified bottom wall and a cylindrical side wall terminating in an wide threaded open bottle neck A bottle cap chamber is also provided for sealingly mating to the wide threaded open bottle neck to form a completed bottle assembly. The completed bottle assembly is similar in shape and size to conventional plastic beverage bottles. The bottle cap chamber has a wide left-handed threaded base that sealingly mates to the left-handed wide threaded open bottle neck. The bottle cap chamber terminates in a conventional right handed 28 mm., 48 mm. or similarly threaded neck. A special time release threaded cap is also provided to sealing mate with the bottle cap chamber threaded neck and seal off the bottle contents. Thus, twisting the threaded cap to open the container, will tighten the mating threads between the bottle cap chamber and the bottle cap chamber, preventing the larger opening from being easily opened.

The bottle cap chamber has a deep receptacle assembly holding groove for attaching a a support cap member holding ring that will eventually hold the high pressure receptacle assembly in position inside the bottle.

The high pressure receptacle consists of an inner injection-stretch-blown or blow-molded unified plastic receptacle. The approximate length of the receptacle is of the same order as the bottle and its diameter is less than the threaded open bottle neck so that it can be inserted into the bottle. The high pressure receptacle a cylindrical body with a half-spherical domed bottom and terminates at its upper open end in a narrow cylindrical neck that has a small opening for introducing high pressure cryogenic gases. A small stepped o-ring grove acts as an o-ring seat for a cryogenic class o-ring member. The receptacle cylindrical neck is threaded to mate with the threads of a high pressure support cap member. A unified injection-stretch-blown plastic PET sleeve member is provided to intimately encase and structurally support the high pressure receptacle completely. The sleeve member has an straight open mouth and is essentially an open cylindrical part with a half-spherical domed bottom. Advantageously, the high pressure receptacle fits snugly inside the sleeve member and the sleeve member acts as a support structure for added strength. The sleeve member is designed with circumferential ridges on the outer surface that act as stress containing bands to withhold high pressure hoop stresses that may be subjected to the assembled unit when high pressure cryogenic gases are stored therein.

The sleeve member must injection-stretch-blown from a Polyester-Tetraphalate,(PET) preform that has a cylindrical neck that is larger in diameter than its main body, so that when the smaller diameter body is stretch-blown, the sleeve that is formed looks essentially like an even cylinder that has all the advantages of an injection-stretch-blown and oriented PET container. Thus, the sleeve member can handle a tremendous amount of pressure stresses.

When the high pressure receptacle is threaded sealingly unto the support cap member, the support cap member is shaped to fit snugly over the tapering neck of the high pressure receptacle to act as a support structure for the high pressure receptacle. Also, the support cap main body intimately is a cylindrical shape that tightly fits into the inner surface of the cylindrical wall of the sleeve member. This way, the support cap member becomes a structural bridge between the sleeve member and the high pressure receptacle. The support cap member also has a concentric ring member that is connected to its top end so that a cylindrical gap exists between the concentric ring member inner wall and the support cap main body. Thus, the inner wall of this concentric ring member intimately mates with the outer wall of the open sleeve mouth. The concentric ring member terminates in a small inner step that is designed to act as a snap that lockingly attaches to a small raised snap-ring on the sleeve's outer wall, so that there is no possibility of unmating the two once they are locked together. A protruding support cap stud member is also present at the top surface of the support support cap member. At the bottom edge of the ring member, two or more radially protruding thin walled holding members that are attached. They are designed to follow the inner contour of the beverage bottle so that they eventually terminate on a receptacle assembly holding ring that attaches to the receptacle assembly holding groove on the bottle cap chamber.

When the high pressure receptacle has been attached to support cap member, and the assembly then attached to the sleeve to form a completed receptacle assembly, a final part called the actuation cap is placed into the small receptacle hole to form a plug that contains the high pressure gases in place. The actuation cap is designed to fit sealingly over the support cap member, and forms a sealed chamber with the support cap member. A protruding actuation tube member projects from the top of the actuation cap in the direction away from the base dome of the high pressure receptacle. The inner wall of a protruding actuation tube member forms a tight fit over protruding support cap stud member mentioned above, so that the actuation chamber formed between the support cap and the actuation cap is almost air tight when the protruding actuation tube member mates with the protruding support cap stud member and the actuation cap body mates with the support cap. However, this actuation chamber, even though airtight, will over a long period of time, say two or three hours, be filled with carbonation gases that bleed inside it through the joints and the walls of the actuation cap to equilibrate the carbonation pressure from the outside with the pressure in the actuation chamber. The actuation feed tube forms a passageway for fluids from the inside of the inside of the actuation cap.

Further, a cylindrical actuation sealing plug protrudes downward into the inner center of the high pressure receptacle. The actuation sealing plug becomes hollow and continues as a refrigerant feed tube a distance of about a ¼ inch from where the o-ring seats in the high pressure receptacle entrance. Advantageously, the actuation sealing plug acts as a refrigerant receptacle plug when fitted through the o-ring. The refrigerant feed tube from the high pressure receptacle has a small pin-hole that breaks through it tangential to the start of the refrigerant feed tube hole. Advantageously, when the actuation cap is assembled with the receptacle assembly, the actuation sealing plug serves as a plug and keeps any refrigerant from exiting the high pressure receptacle chamber, whereas, when the actuation sealing plug moves away from the receptacle, the seal between the actuation sealing plug and the o-ring breaks when the pin-hole is exposed and refrigerant is raised through the refrigerant feed tube, then through the pin-hole to exist into the actuation chamber. The refrigerant can easily exist by pushing the actuation cap away from the support cap and exposing the actuation feed tube by removing and unplugging the actuation feed tube from the support cap stud member.

The high pressure receptacle is designed to store high pressure liquified cryogenic gases, such as carbon-dioxide, mixtures of aerosol propellants and carbon-dioxide, or a matrix held aerosol propellants with smell ingredients such as a combination of C02 and carbon atoms. The refrigerant used for the cooling process may be designed as a slurry of an activated carbon matrix with CO2 gas trapped inside the matrix. The apparatus further comprises a conventional bottle cap for sealing off the beverage products after being filled.

During manufacture, the support cap member and the receptacle are first assembled as describe above. Then the sub-assembly is then assembled with the sleeve. Then, an o-ring is pled inside the high pressure receptacle o-ring groove. The cryogenic gas is then introduced into the high pressure receptacle by means of a feeder tube that enters into the high pressure receptacle chamber. Air is allowed to bleed off from the high pressure receptacle and cold liquified refrigerant is introduced into the high pressure receptacle chamber. Then, when the refrigerant has been filed to th desired level, the actuation cap is assembled so that actuation sealing plug protrudes downward into the inner center of the high pressure receptacle sealing off the refrigerant from exiting the high pressure receptacle chamber. At the same time, the inner wall of a protruding actuation tube member forms a tight fit over protruding support cap stud member mentioned above, so that the actuation chamber formed between the support cap and the actuation cap is almost air tight. The beverage bottle assembly is then filled with carbonated product and the bottle cap fitted to seal off the product. The finished product is then stored for later use or sale. During storage, carbonation pressure slowly enters the actuation chamber and fills it without carbon-dioxide or whichever gases may be used to pressurize the product.

When a consumer opens the beverage bottle, carbon pressure is released and the actuation chamber now holds a high pressure that atmospheric due to the stored residual gases it has trapped. The actuation cap is pushed away from th support member, and the actuation sealing plug exposes th pin-hole allowing refrigerant to escape into the actuation chamber, than out the actuation tube member into the beverage product. The refrigerant evaporates rapidly and gets out of the bottle.

A special timer release cap is also provided to prevent the end user from completely opening the beverage bottle prior to lowering of the internal pressure caused by the evaporating refrigerant. In one embodiment of the invention a special time release threaded cap is also provided in place of the conventional beverage threaded caps to sealing mate with the bottle cap chamber threaded neck and seal off the bottle contents. Time release cap member is made as either a single part or from two parts depending on the processes used to manufacture it. A serrates inner expandable domed cap is fitted into the time release cap to form an expandable dome cap member. The serrations of the expandable domed cap member generally lay at a diameter less that the inner diameter of the bottle cap threaded neck. The bottle cap chamber threaded neck has a small locking grove on the inside wall of the bottle cap chamber threaded neck, so that the serrations of the domed cap do not interact with the small locking grove during and after assembly. A sealing expandable dome cap edge ridge on the end expandable dome cap member fits snugly into the inside wall of bottle cap chamber threaded neck so that a partial seal is formed between the sealing expandable dome cap edge ridge and the inside wall of bottle cap chamber threaded neck However, when the cap is opened for consumption, the only escape route for the pressurized gases within the product is through the small locking grove and so the pressure within the sealing expandable dome cap will expand the sealing expandable dome cap and serrations of the domed cap will lock into the small locking grove on the inside wall of the bottle cap chamber threaded neck. This action prevents the complete opening of the time release cap member, so that the consumer will have to wait for the complete release of the refrigerant, and thus, the complete cooling of the beverage product before being able to open the beverage container for consumption.

To operate the present invention for use as a self-cooling container, no additional activation means is provided that can be tampered with by a user. The beverage container opening means is opened for the container contents to be consumed. This simultaneously activates the system extracting heat from the container contents by means of evaporative super-cooling.

A self-cooling container apparatus is further provided for retaining container contents such as food or beverages; and a container contents release mechanism for releasing the container contents from the container and also for effectuating the release of liquified gas stored in a high pressure receptacle.

### BRIEF DESCRIPTION OF THE DRAWINGS

Various other objects, advantages, and features of the invention will become apparent to those skilled in the art from the following discussion taken in conjunction with the following drawings, in which:

FIG. 1 shows a the beverage container assembly according to the preferred embodiment of this invention.

FIG. 2 shows a the beverage container assembly according to the preferred embodiment of this invention with a special time release cap opened.

FIG. 3 shows a the beverage container assembly according to the preferred embodiment of this invention with the bottle separated from th bottle cap, and the time release cap.

FIG. 4 shows the high pressure receptacle assembly with the sleeve and high pressure receptacle, held to the grove of the bottle cap by the actuation cap.

FIG. 5 shows the actuation cap attached to the bottle cap, and the high pressure receptacle, separated for clarity from the sleeve.

FIG. 6 shows the support cap member.

FIG. 7 shows the actuation cap member.

FIG. 8 shows the sleeve member.

FIG. 9 shows the high pressure receptacle member.

FIG. 10 shows the support cap member being fitted unto the threaded high pressure receptacle member.

FIG. 11 shows the high pressure receptacle and the support cap assembly.

FIG. 12 shows the high pressure receptacle and the support cap assembly being fitted into the sleeve.

FIG. 13 shows the high pressure receptacle and the support cap assembly fitted into the sleeve.

FIG. 14 shows a cross section of the container assembly.

FIG. 15 shows a cross-section of the receptacle assembly.

FIG. 16 shows a blow-up partial cross-section of the receptacle assembly.

FIG. 17 shows a cut perspective section of the bottle cap and receptacle assembly.

FIG. 18 shows a cut perspective section of the bottle, bottle cap and receptacle assemblies.

FIG. 19 shows a complete cross-section of the bottle, bottle cap, and receptacle assembly.

FIG. 20 shows a blow-up cross-section of the bottle, bottle cap, and receptacle assembly.

FIG. 21 shows a cut-away view of the time release cap and serrated expandable dome assembled unto the bottle cap.

FIG. 22. Shows an exploded view of the time release bottle cap with the serrated expandable dome and the threaded cap body.

FIG. 23 shows the time release cap in an assembled and unified form.

FIG. 24 shows the completed beverage container assembly.

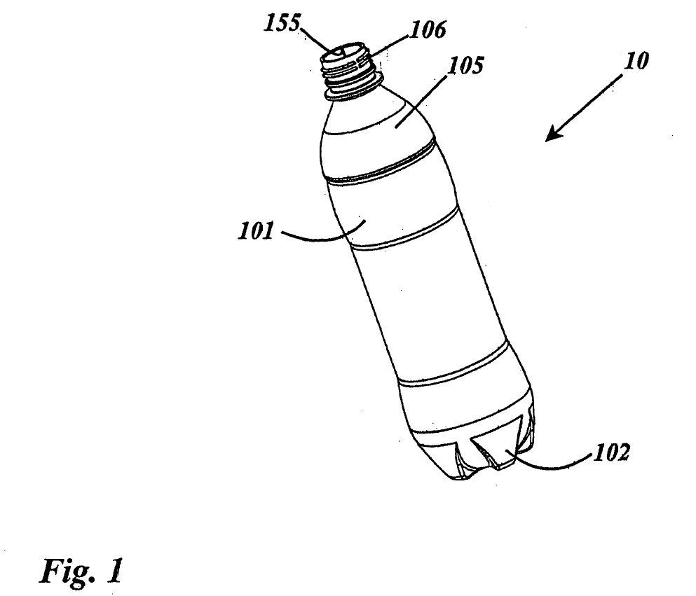

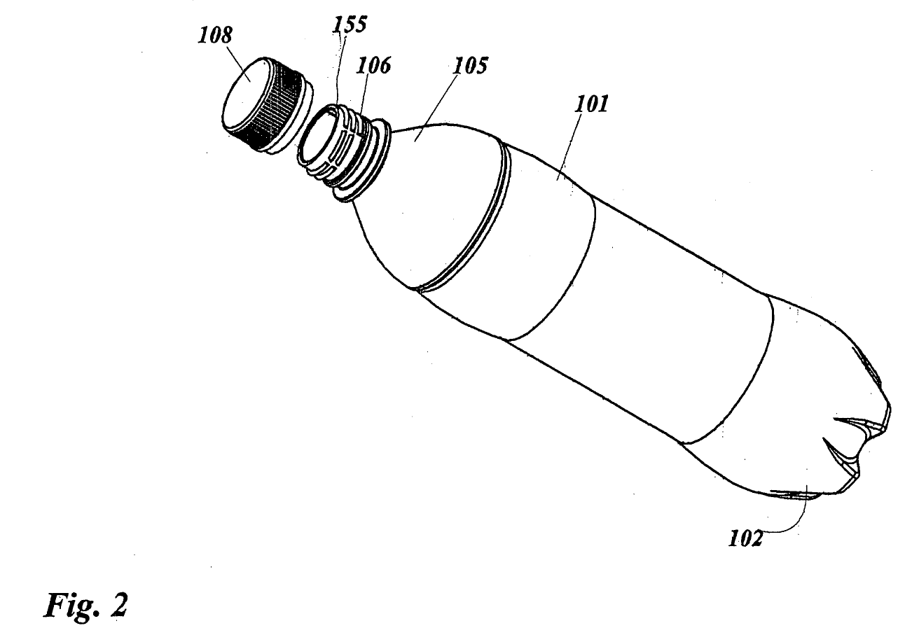

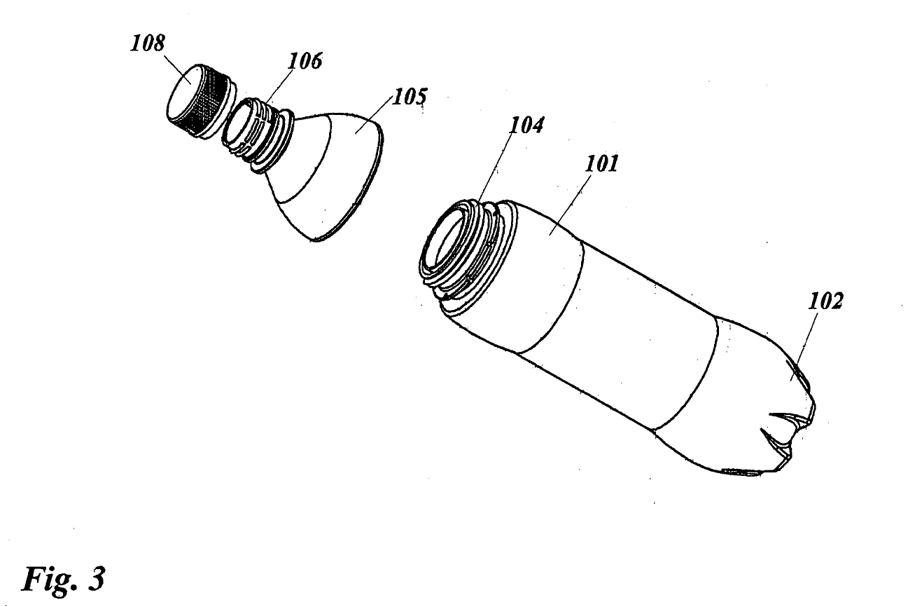

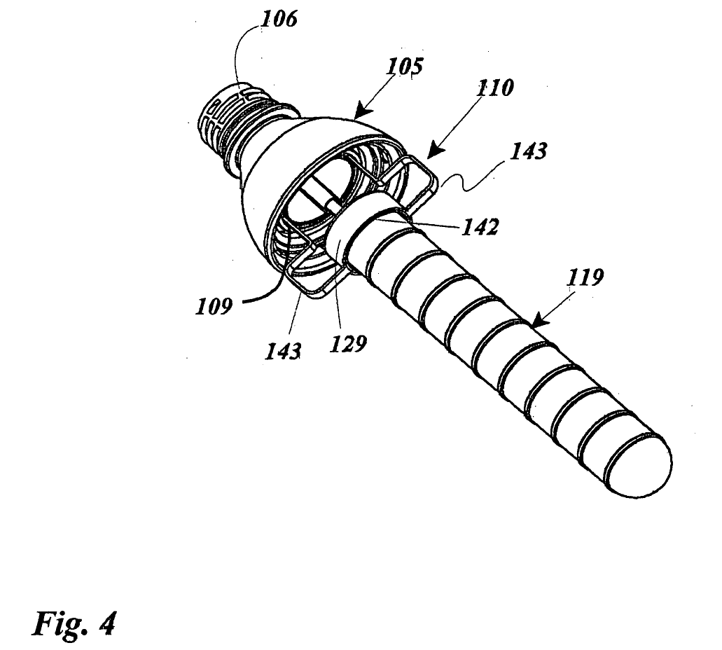

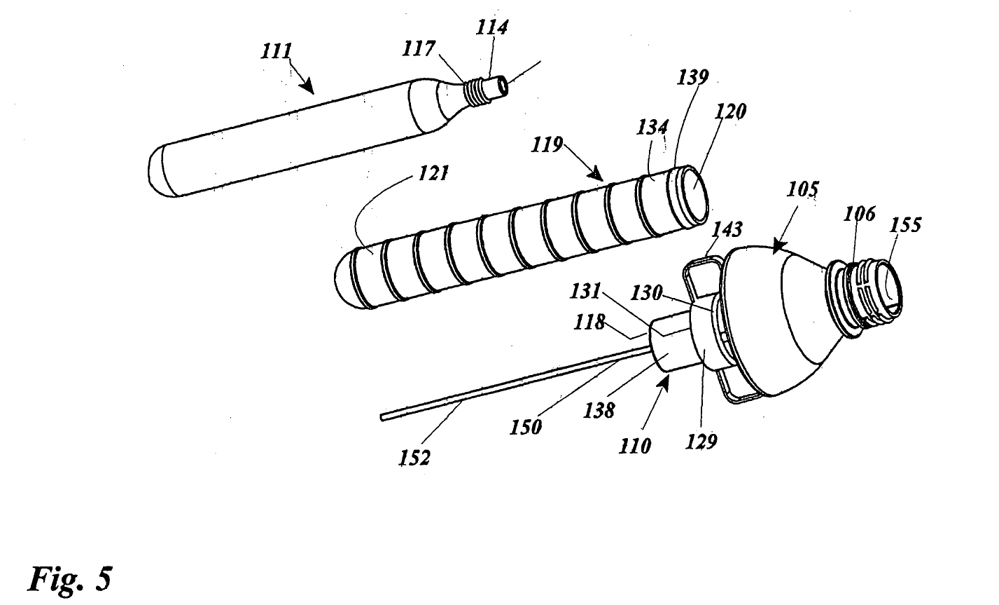

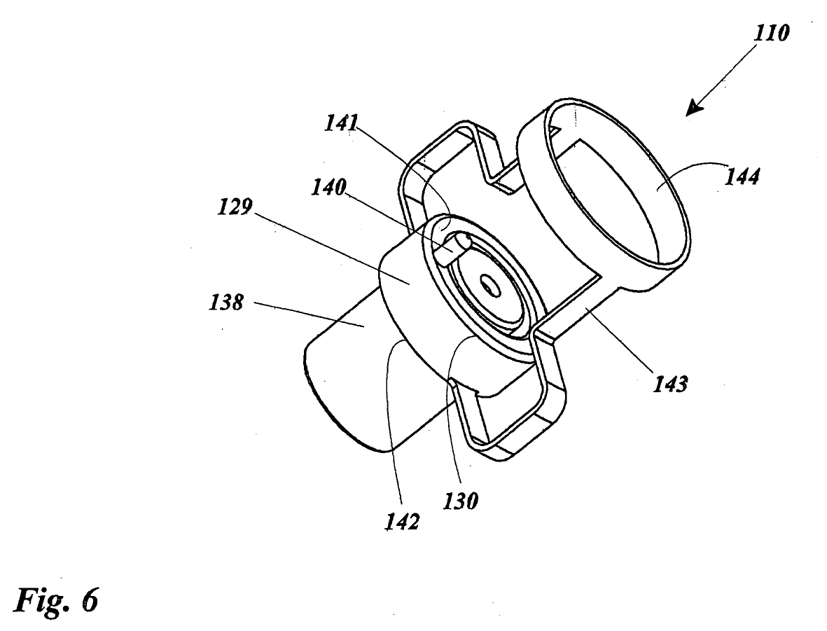

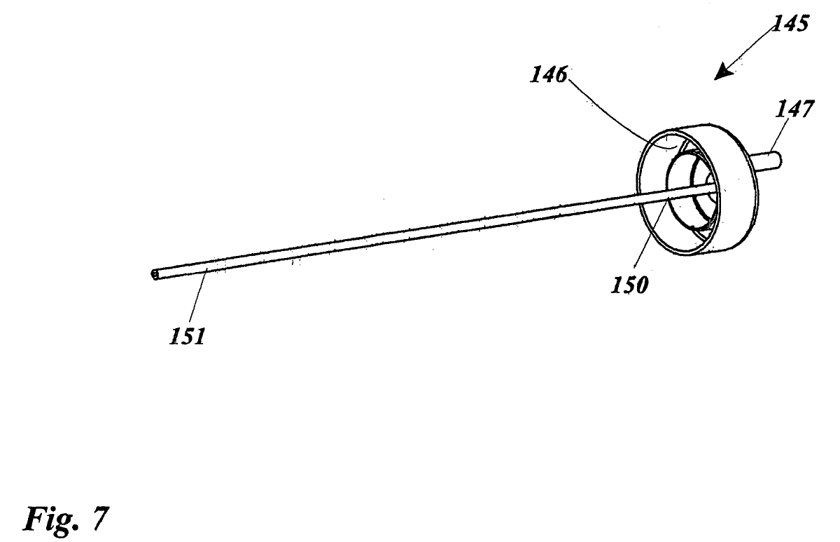

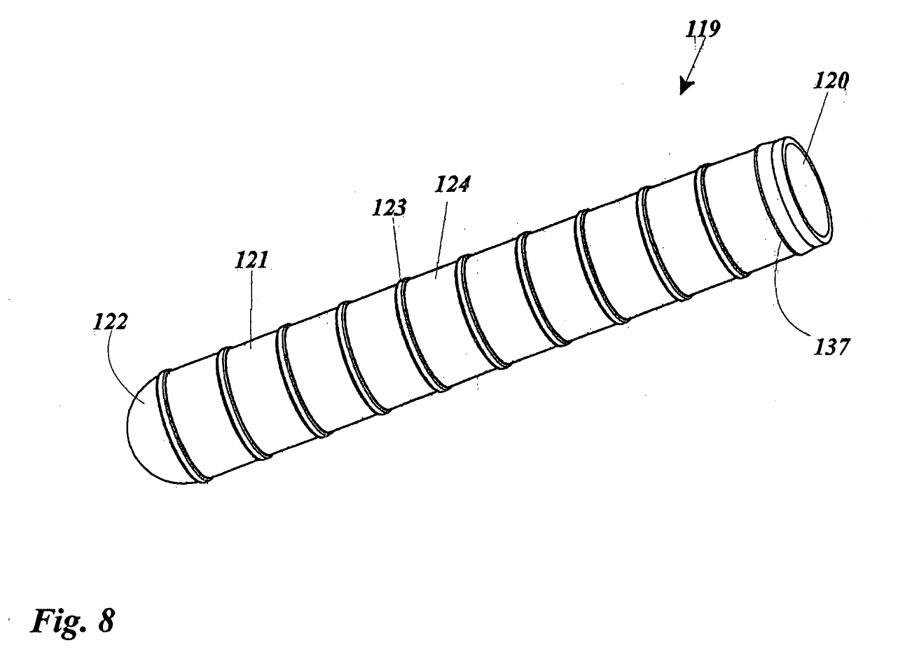

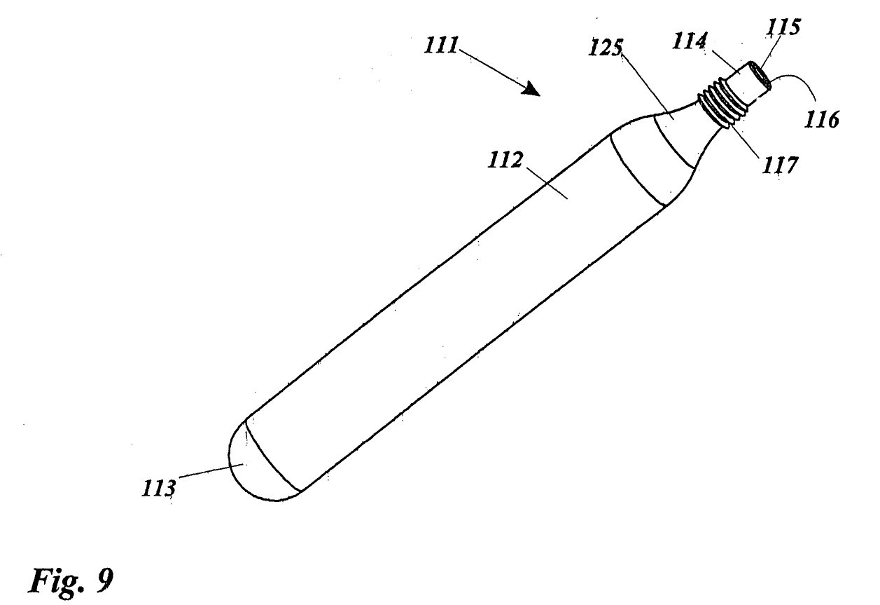

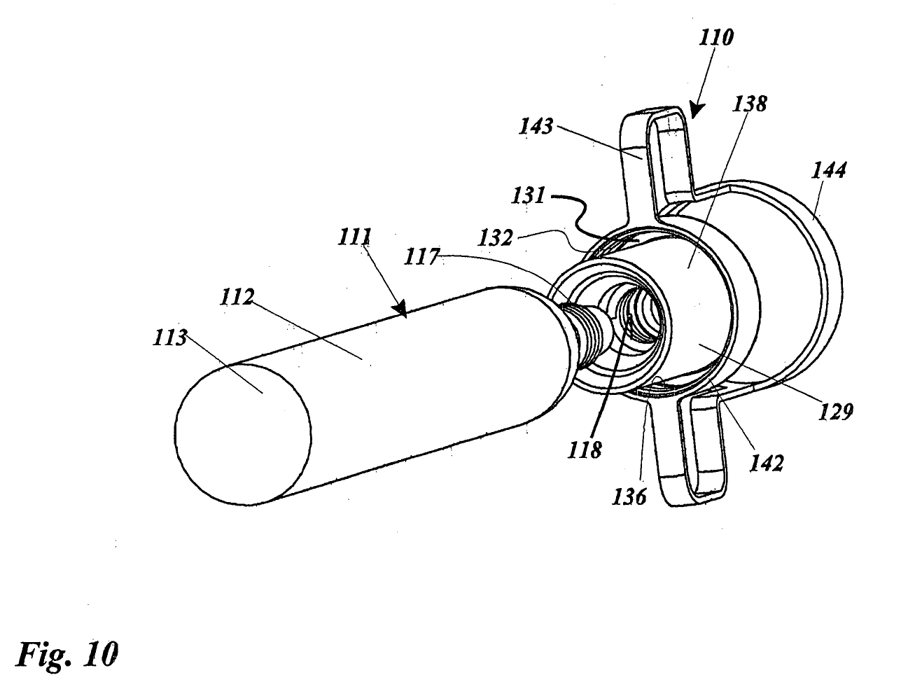

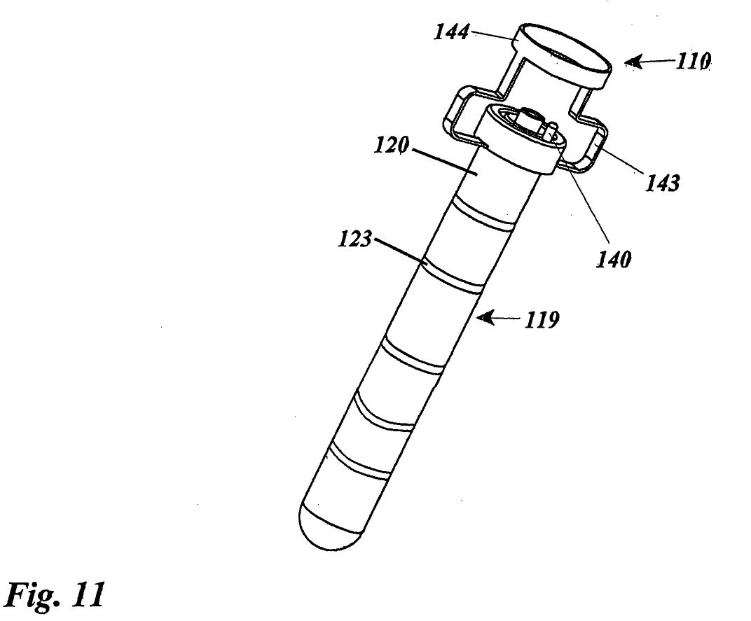

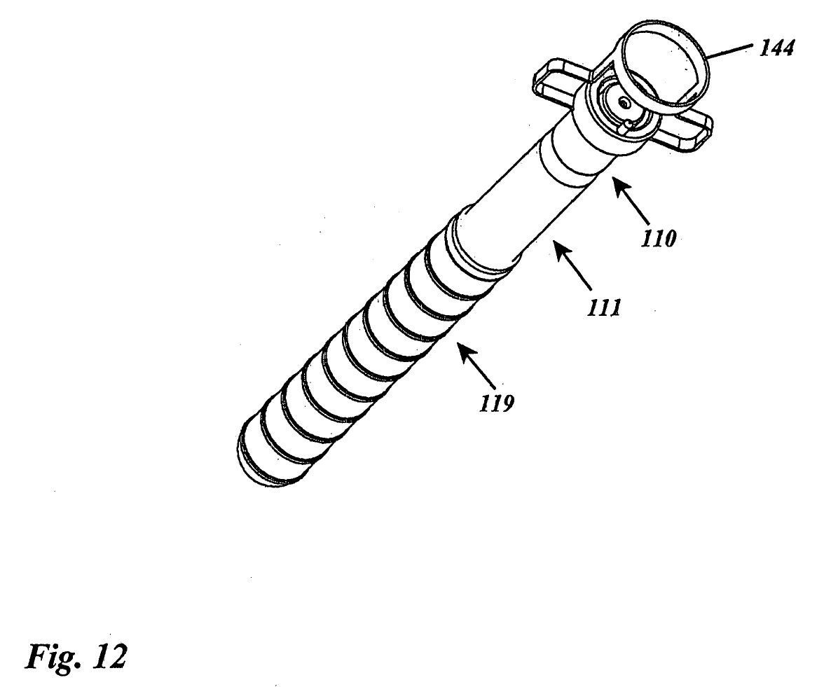

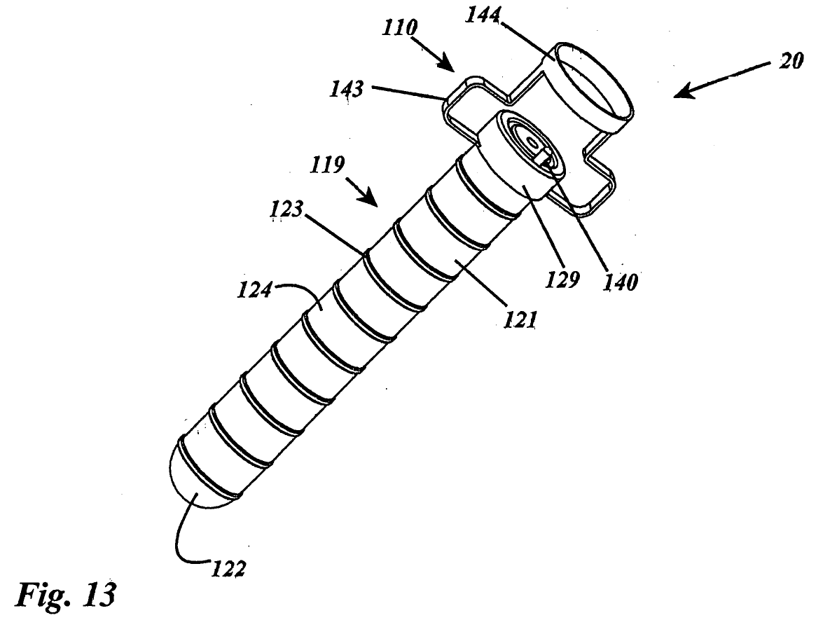

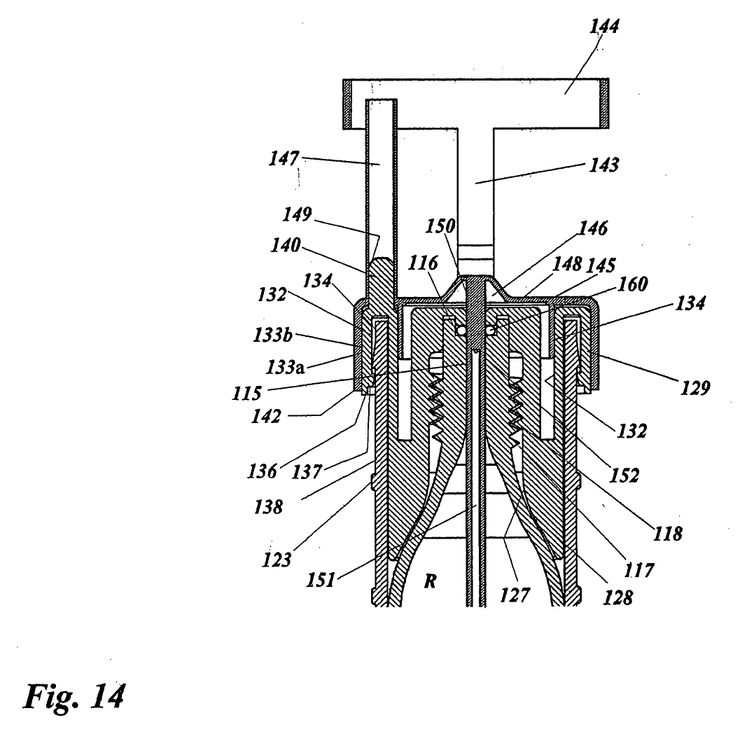

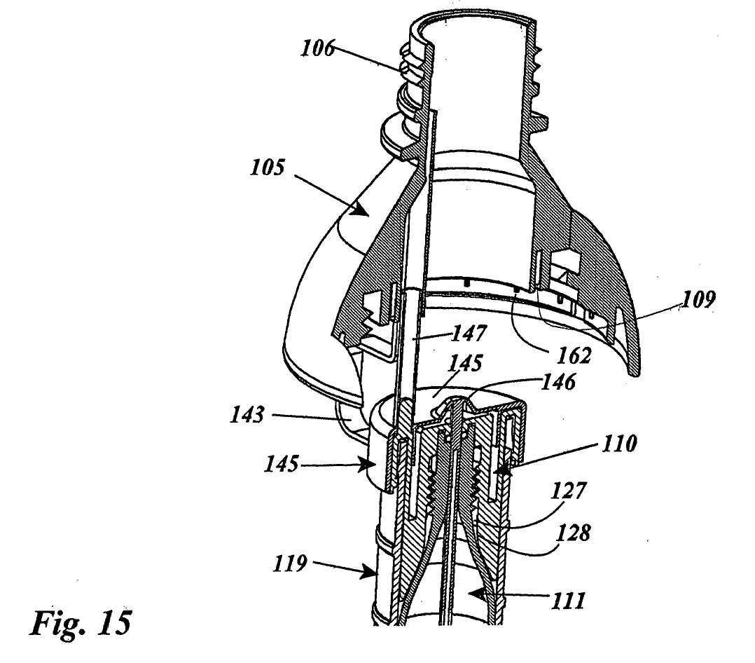

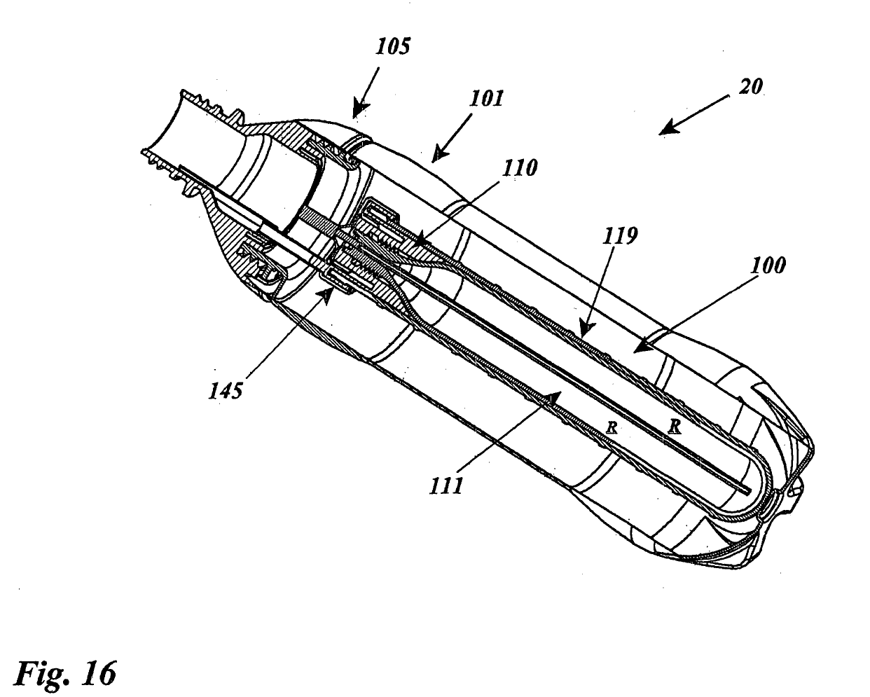

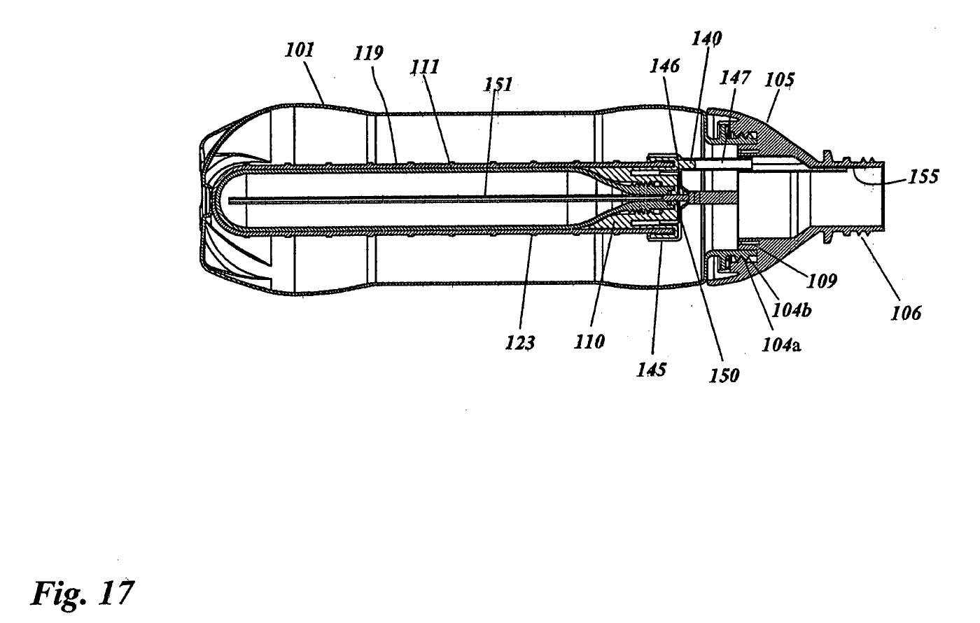

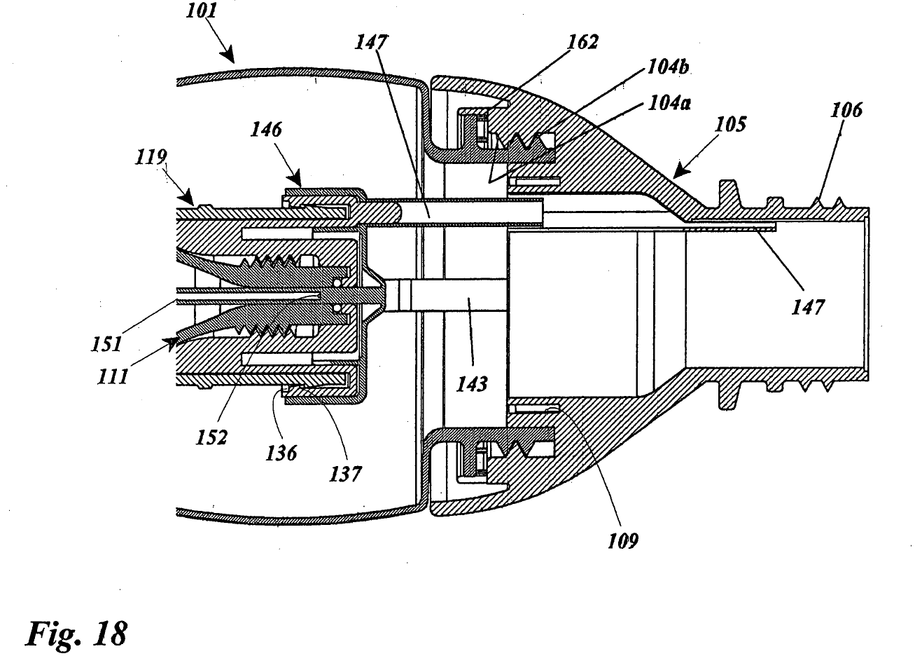

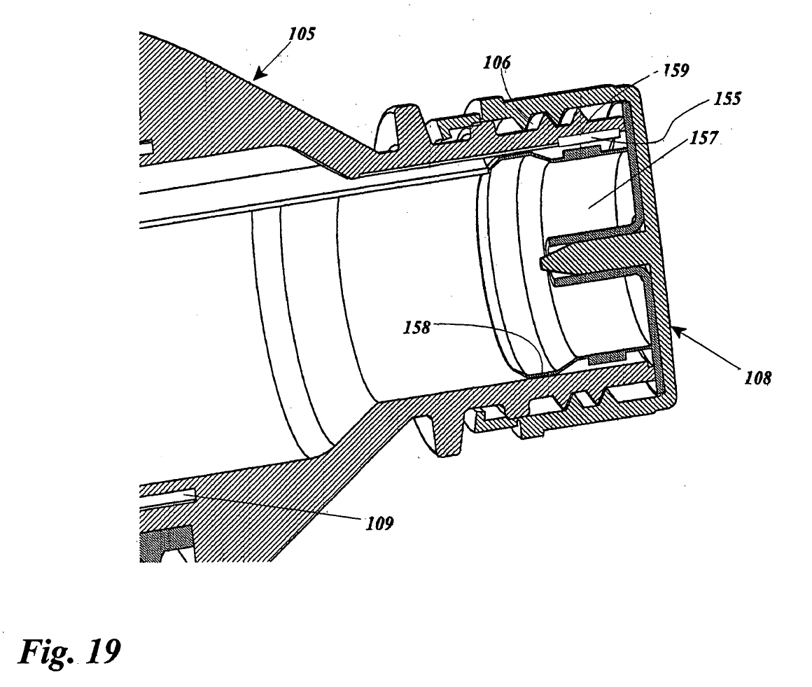

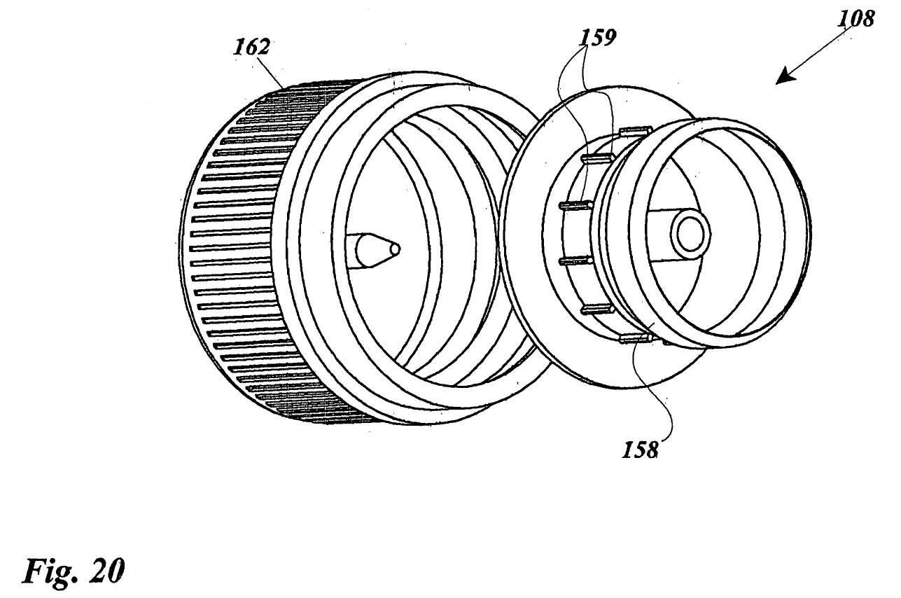

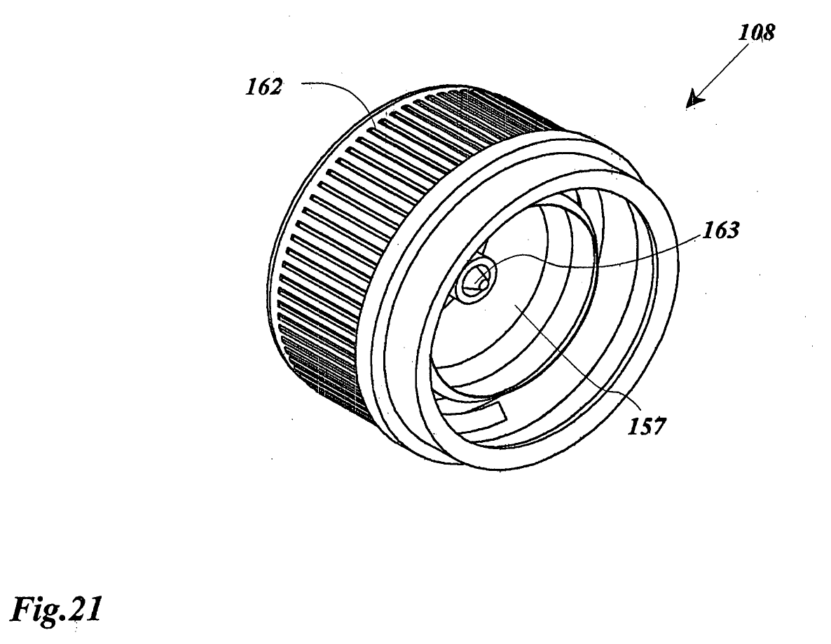

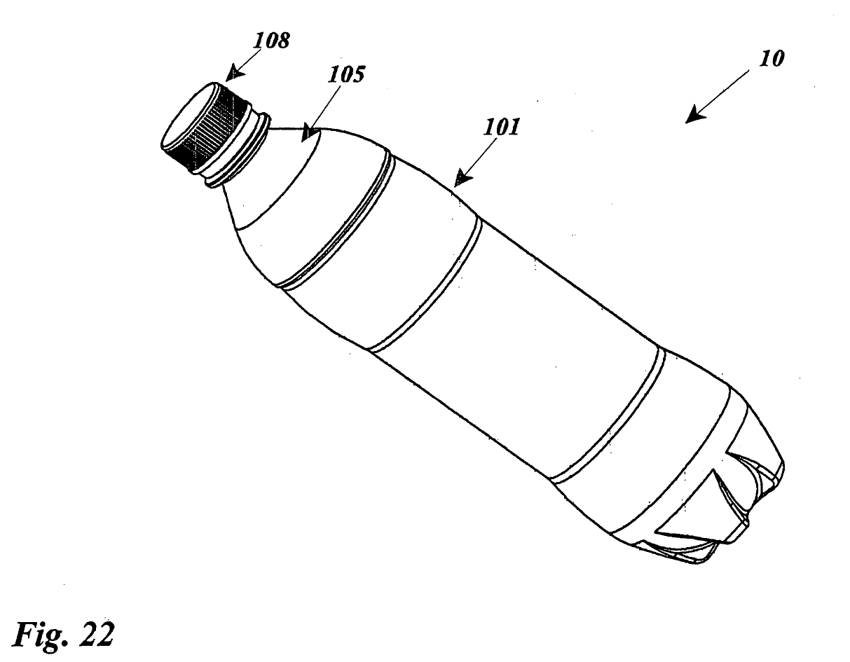

Referring to FIGS. 1-24, for the preferred of several possible embodiments, the apparatus is a conventional beverage or food container 10 such as a plastic or metal container for containing a product 100 to be consumed. In the preferred embodiment, the container 10 is an injection-stretch-blown plastic bottle 101 with a conventional unified bottom wall 102 and a cylindrical side wall 103 terminating in an wide threaded open bottle neck 104. A bottle top camber 105 is also provided for sealingly mating to the wide threaded open bottle neck 104 to form a completed container 10 assembly. The completed container 10 assembly is similar in shape and size to conventional plastic beverage bottles. The bottle top chamber 105 has a wide left-handed threaded base that sealingly mates to the left-handed wide threaded open bottle neck 104. The bottle top chamber 105 terminates in a conventional right handed 28 mm., 48 mm. or similarly threaded neck 106. A special threaded time release cap 108 is also provided to sealing mate with threaded neck 106 and seal off the container 10 contents, Thus, twisting the time release threaded cap 108 to open the container, will tighten the mating threads between the bottle top chamber 105 and the bottle 10, preventing the larger opening from being easily opened.

The bottle top chamber 105 has a deep receptacle assembly holding groove 109 for attaching a support cap member 110 holding ring that will eventually hold a high pressure receptacle 111 assembly in position inside the bottle 101.

The high pressure receptacle 111 consists of an injection-stretch-blown or blow-molded unified plastic body. The approximate length of the high pressure receptacle 111 is of the same order as the bottle 101 and its diameter is less than the threaded open bottle neck 104 so that it can be inserted into the bottle 101. The high pressure receptacle 111 has a cylindrical body 112 with a half-spherical domed bottom 113 and terminates at its upper open end in a narrow cylindrical neck 114 that has a small receptacle opening 115 for introducing high pressure cryogenic refrigerants R. A small stepped o-ring grove 116 acts as a seat for a cryogenic class o-ring member 117. The receptacle cylindrical neck 114 has receptacle thread 117 to mate with the support cap member threads 118 of the support cap member 110.

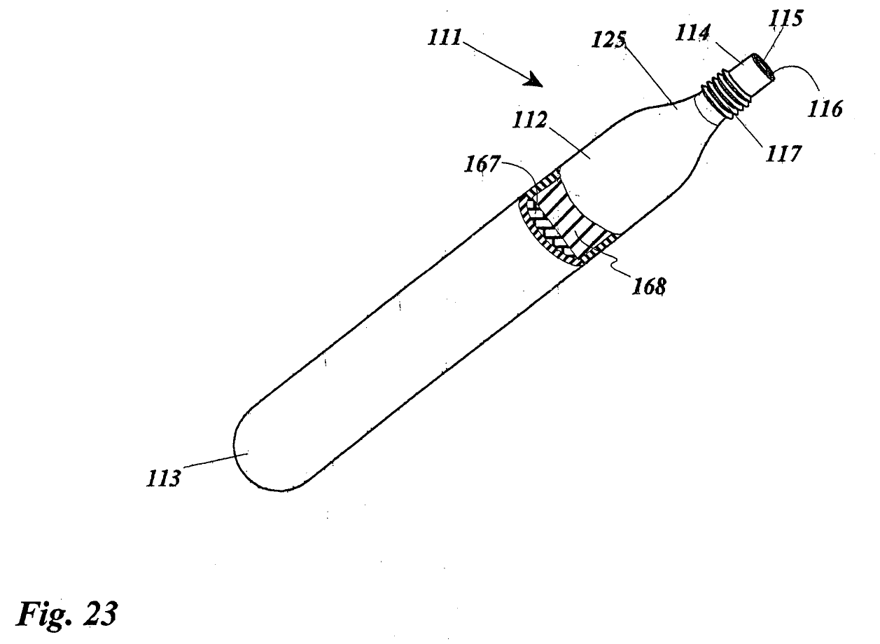

High pressure receptacle 111 could also be constructed in a variety of ways. For example, it could be made from a continuous extrusion of a tube into a mold that is shaped like a bottle so that the material of the tube fuses and the end product becomes a piece that is shaped like a bottle but with a continuos tubular chamber as shown in FIGS. 23,24 and 25. Tube members 167 are shown with integral passages 168 for storing the refrigerant R. In this case the preferred method of manufacture is to form the high pressure receptacle 111, then to insert it into a mold that will contain it during the extrusion of the tube members 167. The tube members 167 could be contiguous or separated so that multiple chambers result forming a single contiguous chamber within high pressure receptacle 111 for the refrigerant R storage.

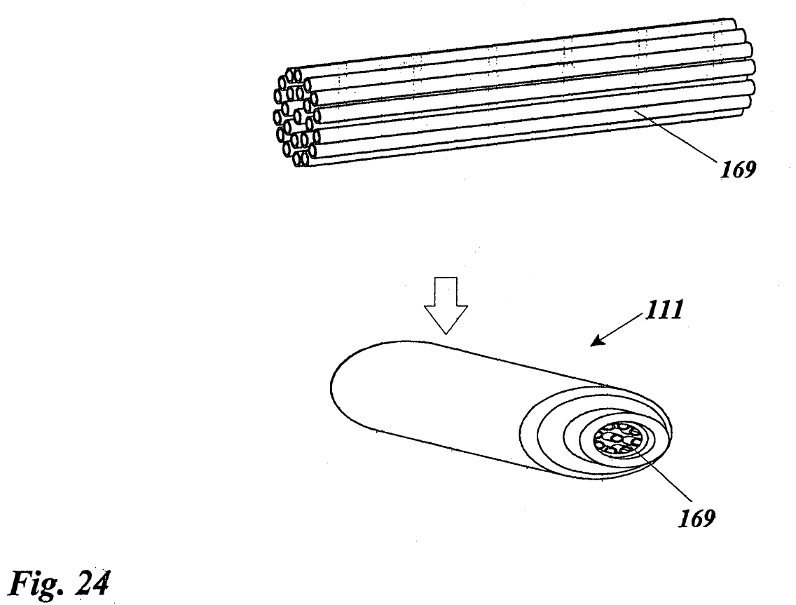

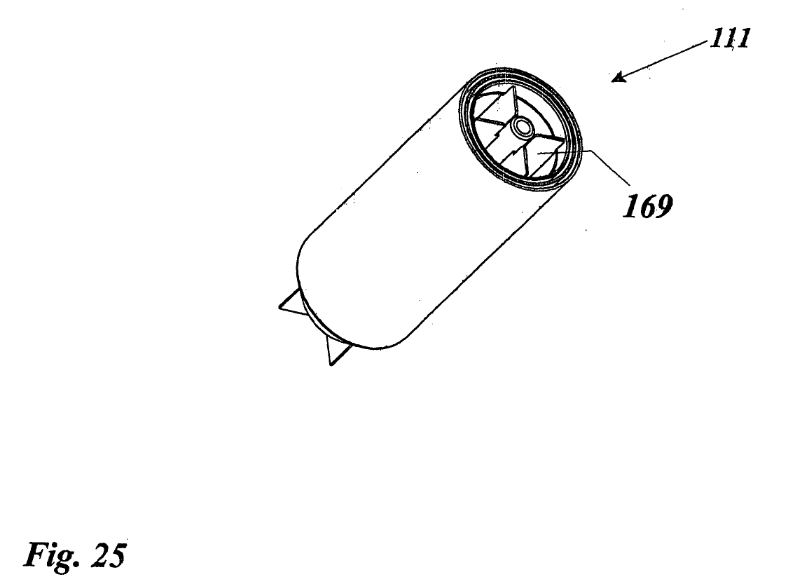

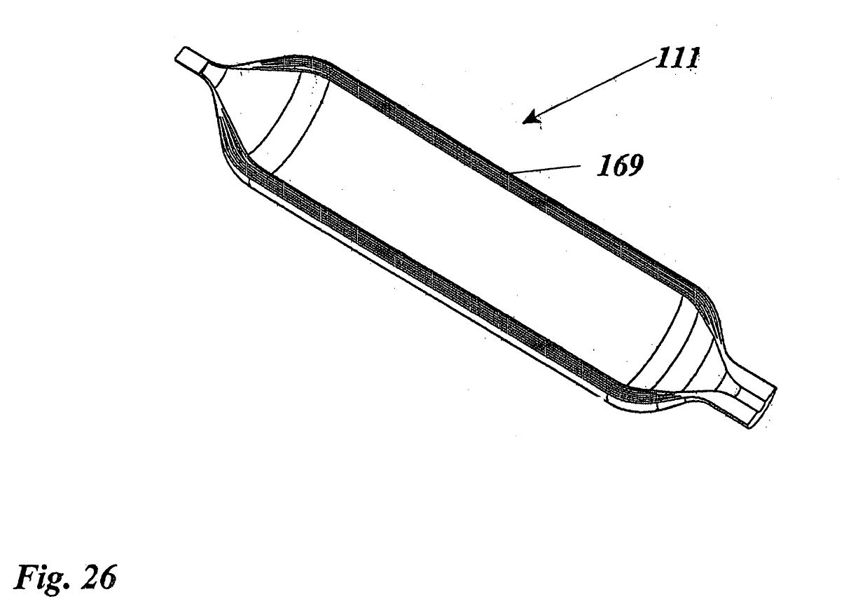

Yet another method of manufacture of high pressure receptacle 111 is to extrude a multiple tube extrusion and then compressing the extrusion while it is hot to for a contiguous chamber that is fused into the shape of the receptacle as shown in FIGS. 24 and 25. Tube members 169 are extruded into a mold cavity that then clamps them into the desired shape, fusing the bottom and leaving passages 170 open for introducing the refrigerant R.

A unified injection-stretch-blown plastic PET sleeve member 119 is provided to intimately encase and structurally support the high pressure receptacle 111 completely. The sleeve member 119 has an straight open cylindrical neck 120 and is essentially an open cylindrical part 121 with a half-spherical domed bottom 122. Advantageously, the high pressure receptacle 111 fits snugly inside the sleeve member 119 and the sleeve member 119 acts as a support structure for added strength. The sleeve member 119 is designed with circumferential ridges 123 on the outer surface 124 that act as stress containing bands to withhold high pressure hoop stresses that may be subjected to the assembled unit when high pressure cryogenic gases are stored therein.

The sleeve member 119 must injection-stretch-blown from a Polyester-Tetraphalate,(PET) or a high tensile strength material. It may also be made from a metal piece by extrusion or-deep drawing. In the plastic format, the sleeve member 119 could be made from a preform that has a cylindrical neck 120 that is larger in diameter than its main cylindrical body, so that when the smaller diameter body is stretch-blown, the sleeve member 119 that is formed looks essentially like an even cylinder that has all the advantages of an injection-stretch-blown and oriented PET container. Thus, the sleeve member 119 can handle a tremendous amount of pressure stresses.

When the high pressure receptacle 111 is threaded sealingly unto the support cap member 110, the support cap member 110 is shaped to fit snugly over the tapering neck 125 of the high pressure receptacle 111 to act as a support structure for the high pressure receptacle 111. Also, the support cap member 110 main body 126 is a cylindrical shape with a main body wall 138 that tightly fits into the inner surface 127 of the cylindrical wall 128 of the sleeve member 119. This way, the support cap member 110 becomes a structural bridge between the sleeve member 119 and the high pressure receptacle 111. The support cap member 110 also has a concentric ring member 129 that is connected to its top end 130 so that a cylindrical gap 131 exists between the concentric ring member inner wall 132 and the support cap member 110 main body wall 138. Thus, the concentric ring member inner wall 132 intimately mates with the outer wall 134 of the sleeve member cylindrical neck 120. The concentric ring member 129 terminates in a small inner step 136 that is designed to act as a snap that lockingly attaches to a small raised snap-ring 137 on the sleeve member 119's outer wall 139, so that there is no possibility of unmating the two once they are locked together. A protruding support cap stud member 140 is also present at the top surface 141 of the support cap member 110. At the bottom edge 142 of the ring member 129, two or more radially protruding thin walled holding members 143 that are attached. Holding members 143 are designed to follow the inner contour of bottle 101 so that they eventually terminate on a receptacle assembly holding ring 144 that attaches to the receptacle assembly holding groove 109 on the bottle top chamber 105.

When the high pressure receptacle 111 has been attached to support cap member 110, and the assembly then attached to the sleeve member 119 to form a completed receptacle assembly 20, a final part called the actuation cap 145 is placed into the small receptacle opening 115 to form a plug that contains the high pressure refrigerant gases R inside of the high pressure receptacle 111. The actuation cap member 145 is designed to fit sealingly over the support cap member 110, and forms a sealed actuation chamber 146 with the support cap member 110. A protruding actuation tube member 147 projects from the top 148 of the actuation cap member 145 in the direction away from the high pressure receptacle 111. The inner wall 149 of a protruding actuation tube member 147 forms a tight fit over protruding support cap stud member 140 mentioned above, so that the actuation chamber 146 formed between the support cap member 110 and the actuation cap member 145 is almost air tight when the protruding actuation tube member 147 mates with the protruding support cap stud member 140 and the actuation cap member 145 body mates with the support cap member 110. However, this actuation chamber 146, even though airtight, will over a long period of time, say two or three hours, be filled with carbonation gases C that bleed inside it through the joints and the walls of the actuation cap member 145 to equilibrate the carbonation pressure from the outside with the pressure in the actuation chamber 146. The actuation tube member 147 forms a passageway for fluids from the actuation chamber 146.

Further, a cylindrical actuation sealing plug 150 protrudes downward into the inner center of the high pressure receptacle 111. The actuation sealing plug 150 becomes hollow and continues as a refrigerant feed tube 151 a distance of about a ¼ inch from where the o-ring member 117 seats in the high pressure receptacle 111 entrance. Advantageously, the actuation sealing plug 150 acts as a refrigerant receptacle plug when fitted through the o-ring member 117. The refrigerant feed tube 151 from the high pressure receptacle 111 has a small pin-hole 152 that breaks through it tangential to the start of the refrigerant feed tube hole 153. Advantageously, when the actuation cap member 145 is assembled with the high pressure receptacle 111 and the sleeve member 119, the actuation sealing plug 150 serves as a plug and keeps any refrigerant R from exiting the high pressure receptacle 111, whereas, when the actuation sealing plug 150 moves away from the recetacle, the seal between the actuation sealing plug 150 and the o-ring member 117 breaks when the pin-hole 152 is exposed and refrigerant R is raised through the refrigerant feed tube 151, then through the pin-hole 152 to exist into the actuation chamber 146. The refrigerant R can easily exist by pushing the actuation cap member 145 away from the support cap member 110 and exposing the actuation tube member 147 by removing and unplugging the actuation feed tube from the support cap stud member 140.

The high pressure receptacle 111 is designed to store high pressure liquified cryogenic gases, such as carbon-dioxide, mixtures of aerosol propellants and carbon-dioxide, or a matrix held aerosol propellants with smell ingredients such as a combination of C02 and carbon atoms. The refrigerant R used for the cooling process may be designed as a slurry of an activated carbon matrix with CO2 gas trapped inside the matrix The apparatus further comprises a conventional bottle cap for sealing off the beverage product 100 after being filled.

During manufacture, the support cap member 110 and the receptacle are first assembled as describe above. Then the sub-assembly is then assembled with the sleeve member 119. Then, an o-ring is placed inside the high pressure receptacle 111 o-ring groove. The cryogenic gas is then introduced into the high pressure receptacle 111 by means of a feeder tube that enters into the high pressure receptacle 111 chamber 147. Air is allowed to bleed off from the high pressure receptacle 111 and cold liquified refrigerant R is introduced into the high pressure receptacle 111 chamber 147. Then, when the refrigerant R has been filed to the desired level, the actuation cap member 145 is assembled so that actuation sealing plug 150 protrudes downward into the inner center of the high pressure receptacle 111 sealing off the refrigerant R from exiting the high pressure receptacle 111 chamber 147. At the same time, the inner wall of a protruding actuation tube member 147 forms a tight fit over protruding support cap stud member 140 mentioned above, so that the actuation chamber 146 formed between the support cap member 110 and the actuation cap member 145 is almost air tight. The beverage container 10 assembly is then filled with carbonated product 100 and the bottle cap fitted to seal off the product 100. The finished container 10 is then stored for later use or sale. During storage, carbonation pressure slowly enters the actuation chamber 146 and fills it without carbon-dioxide or which ever gases may be used to pressurize the product 100.

When a consumer opens the beverage container 10, carbon pressure is released and the actuation chamber 146 now holds a high pressure that atmospheric due to the stored residual gases it has trapped. The actuation cap member 145 is pushed away from th support member, and the actuation sealing plug 150 exposes the pin-hole 152 allowing refrigerant R to escape into the actuation chamber 146, than out the actuation tube member 147 into the beverage chamber 160 or falls directly into product 100 and cools it by absorbing heat and evaporating rapidly. The refrigerant R can be sublimated directly from the beverage product 100 and evaporates rapidly, so that gas formed escapes through the locking grove 155 and gets out of the container 10.

A special time release cap 108 is also provided to prevent the end user from completely opening the beverage container 10 prior to lowering of the internal pressure caused by the evaporating refrigerant R. In one embodiment of the invention a special time release threaded cap is also provided in place of the conventional beverage threaded caps to sealing mate with the bottle top chamber 105's threaded neck 106 and seal off the container 10 product 100. Time release cap 108 is made as either a single part with time release-cap- body 162, or from two parts depending on the processes used to manufacture it. A serrated inner expandable domed cap 157 is fitted into the time release cap 108 through a stud and socket means 163 to form an expandable dome cap member inside time release cap 108. The serrations of the expandable domed cap 157 generally lay at a diameter less that the inner diameter of the threaded neck 106. The bottle top chamber 105's threaded neck 106 has a small locking grove 155 on the inside wall of the bottle top chamber threaded neck 106, so that the serrations of the expandable domed cap 157 do not interact with the small locking grove 155 during and after assembly. A sealing expandable dome cap edge-ridge 158 on the end expandable dome cap 157 fits snugly into the inside wall 107 of bottle top chamber 105's threaded neck 106, so that a partial seal is formed between the sealing expandable dome cap edge-ridge 158 and the inside wall 107 of bottle top chamber 105's threaded neck 106. However, when the time release cap 108 is opened for consumption, the only escape route for the pressurized liquified refrigerant R within the product 100 is through the small locking grove 155 and so the pressure within the sealing expandable dome cap 157 will expand it and the serrations 159 of the expandable domed cap 157 will lock into the small locking grove 155 on the inside wall 107 of the bottle top chamber 105 threaded neck 106. This action prevents the complete opening of the time release cap 108, so that the consumer will have to wait for the complete release of the refrigerant R, and thus, the complete cooling of the beverage product 100 before being able to open the beverage container 10 for consumption.

To operate the present invention for use as a self-cooling container, no additional activation means is provided that can be tampered with by a user. The beverage container 10 opening means is opened for the container product 100 to be consumed. This simultaneously activates the apparatus extracting heat from the container product 100 by means of evaporative super-cooling.

A self-cooling container apparatus 10 is further provided for retaining container product 10 such as food or beverages; and a container contents release mechanism for releasing the container product 100 from the container 10 and also for effectuating the release of liquified refrigerant R stored in a high pressure receptacle 111.

While the above specifications reveal one of many embodiments of the present invention, it must be noted that several different representations of the invention could be constructed by one skilled in the art without limiting the generality of the invention.

1. A self-cooling beverage container, comprising:
a container having a container bottom well and a container side wall sealing connected to said container bottom wall and terminating in a container top opening;
a top chamber removably fastened to said container side wall and covering and closing said container top opening, said top chamber having a chamber top opening removably fitted with a chamber cap and having a chamber bottom opening comprising a support cap member holding structure having a gas passing passageway with pressure receptacle mounting means and sleeve member mounting means;
a pressure receptacle containing a refrigerant and having a receptacle opening and being removably mounted to said pressure receptacle mounting means and extending downwardly into said container;
a sleeve member having a tubular sleeve member side wall and having a sleeve member bottom wall sealingly connected to said sleeve member side wall, said sleeve member enclosing said pressure receptacle and removably mounted to said sleeve member mounting means;
and an actuation cap fitted over said pressure receptacle opening and having an actuation sealing plug extending downwardly into the pressure receptacle sealing the refrigerant within the pressure vessel and having an upwardly protruding actuation tube member;
such that removing said chamber cap causes said actuation cap member to move away from said support member permitting said refrigerant to escape from said pressure receptacle and from said container drawing heat from and thereby cooling container contents.
